(19) United States
(12) Patent Application Publication
(10) Pub. No.: US 2026/0322033 A1
(43) Pub. Date: Oct. 15, 2026

(54) CONNECTION INTERFACE COMPATIBLE WITH HARDWARE SPECIFICATION OF TYPE C UNIVERSAL SERIAL BUS AND APPLICATION THEREOF

(71) Applicant: PRIMAX ELECTRONICS LTD., Taipei City (TW)

(72) Inventors: TZU-HSIANG LIN, Taipei City (TW); Kuan-Wei Chu, Taipei City (TW); Ming-Hsi Hua, Taipei City (TW); Shih-Chieh Liao, Taipei City (TW); Chia-Hao Wei, Taipei City (TW)

(21) Appl. No.: 19/204,674

(22) Filed: May 12, 2025

(30) Foreign Application Priority Data
Apr. 9, 2025 (TW) 114113403

(51) Int. Cl. H01R 13/631; H01R 24/60

(52) U.S. Cl. CPC H01R 13/631; H01R 24/60

(57) ABSTRACT

A connection interface is compatible with a hardware specification of a Type C universal serial bus. The connection interface includes a connection interface hardware structure and 24 metal docking structures. The connection interface hardware structure is compatible with the hardware specification of the Type C universal serial bus. The connection interface is one of a plug connection interface and a receptacle connection interface compatible with the Type C universal serial bus. The 24 metal docking structures are symmetrically distributed within the connection interface in two sets. Each set contains 12 metal docking structures. The 24 metal docking structures support simultaneous transmission of two USB2.0 data signals.

### FIELD OF THE INVENTION

The present invention relates to a connection interface for a universal serial bus (USB) and its application, and more particularly to a connection interface compatible with the hardware specifications of Type C universal serial bus (USB-C) and its application.

### BACKGROUND OF THE INVENTION

For modern people, smart electronic products such as computers and mobile phones have become indispensable products in lives. In order to support the above-mentioned smart electronic products, many electronic peripheral devices have been developed. For example, the electronic peripheral devices include mobile hard drives for backing up data, wired or wireless chargers for providing charging power, and card readers for reading data storage cards of various storage specifications (e.g., SD or CF specifications). However, these electronic peripheral devices are usually independent of each other. That is, these electronic peripheral devices cannot transmit data between each other or communicate with each other. Even if a host (e.g., a computer) is used to communicate with different electronic peripheral devices, it is usually necessary to use a variety of signal transmission cables of different specifications to complete the task. In other words, for meeting different usage needs, modern people are surrounded by too many and too complicated electronic peripheral devices and signal transmission cables, which causes considerable troubles in uses and lives.

In order to overcome the drawbacks of the conventional technologies, it is important to provide a connection interface with enhanced use flexibility to provide simplified connection between different devices while meeting the various application requirements of numerous users and reducing the using complexity between different electronic peripheral devices.

### SUMMARY OF THE INVENTION

An object of the present invention provides a connection interface compatible with the hardware specification of a Type C universal serial bus (USB-C).

Another object of the present invention provides the application of the connection interface of the present invention in a modular peripheral device composed of a host and at least one expansion unit. Consequently, the host and the at least one expansion unit can be connected with each other in a modular manner.

In accordance with an aspect of the present invention, a connection interface compatible with a hardware specification of a Type C universal serial bus is provided. The connection interface includes a connection interface hardware structure and 24 metal docking structures. The connection interface hardware structure is compatible with the hardware specification of the Type C universal serial bus. The connection interface is one of a plug connection interface and a receptacle connection interface compatible with the Type C universal serial bus. The 24 metal docking structures are symmetrically distributed within the connection interface in two sets. Each set contains 12 metal docking structures. The 24 metal docking structures support simultaneous transmission of two USB2.0 data signals.

Preferably, in the 24 metal docking structures, four metal docking structures supporting transmission of one of the two USB2.0 data signals and other five metal docking structures collaboratively support transmission of a single USB3.0 data signal.

Preferably, in the 24 metal docking structures, in the 24 metal docking structures, at least two metal docking structures support transmission of I²C data signals, or at least four metal docking structures support transmission of GPIO data signals, or at least two metal docking structures support transmission of a fixed 3.3V power signal, or at least four metal docking structures support transmission of a fixed 19V power signal or a Power Delivery power signal, or at least four metal docking structures support transmission of a ground signal.

In an embodiment, the Power Delivery power signal is operated at a voltage of 5V, 9V, 15V, 19V, 24V, 40V or 48V.

In an embodiment, the connection interface is included in a first electronic device, and an additional connection interface is included in a second electronic device, wherein the connection interface is coupled with a position-limiting coupling structure of the additional connection interface, so that the connection interface and the additional connection interface are permitted to be coupled with each other in a unidirectional mating manner only.

In an embodiment, the position-limiting coupling structure includes a raised coupling structure or a recessed coupling structure.

In an embodiment, the position-limiting coupling structure includes a positioning recess or a positioning post.

In an embodiment, the connection interface is included in a modular peripheral device, and the modular peripheral device includes a host and at least one expansion unit. The host and the at least one expansion unit are connected with each other through the connection interface in a modular connecting manner.

In an embodiment, the modular peripheral device at least includes a Wi-Fi module, at least one memory storage unit, a wireless charging circuit, a first USB interface device, a second USB interface device and a power circuit.

In an embodiment, the first USB interface device is electrically connected with four metal docking structures of the 24 metal docking structures to support transmission of a first one of the two USB2.0 data signals, or the first USB interface device is electrically connected with the four metal docking structures of the 24 metal docking structures to support transmission of the first one of the USB2.0 data signals and other five metal docking structures to support transmission of a single USB3.0 data signal.

In an embodiment, the first USB interface device includes a shared USB2.0/USB3.0 port, or the first USB interface device includes a USB2.0 port and a USB3.0 port.

In an embodiment, the second USB interface device is electrically connected with four metal docking structures of the 24 metal docking structures to support transmission of a second one of the two USB2.0 data signals.

In an embodiment, the second USB interface device includes a USB2.0 port.

In an embodiment, the power circuit is electrically connected with two metal docking structures of the 24 metal docking structures to support transmission of a fixed 3.3V power signal, or the power circuit is electrically connected with four metal docking structures of the 24 metal docking structures to support transmission of a fixed 19V power signal or a Power Delivery power signal.

In accordance with another aspect of the present invention, a connection interface compatible with a hardware specification of a Type C universal serial bus is provided. The connection interface includes a connection interface hardware structure and 24 metal docking structures. The connection interface hardware structure is compatible with the hardware specification of the Type C universal serial bus. The connection interface is one of a plug connection interface and a receptacle connection interface compatible with the Type C universal serial bus. The 24 metal docking structures are distributed within the connection interface. The 24 metal docking structures are permitted to be connected in a unidirectional mating manner only. In the 24 metal docking structures, four metal docking structures supports transmission of a first USB2.0 data signal, four metal docking structures supports transmission of a second USB2.0 data signal, and the four metal docking structures supporting transmission of the first USB2.0 data signal and other five metal docking structures collaboratively support transmission of a single USB3.0 data signal.

Preferably, in the 24 metal docking structures, at least two metal docking structures support transmission of I²C data signals, or at least four metal docking structures support transmission of GPIO data signals, or at least two metal docking structures support transmission of a fixed 3.3V power signal, or at least four metal docking structures support transmission of a fixed 19V power signal or a Power Delivery power signal, or at least four metal docking structures support transmission of a ground signal.

In an embodiment, the Power Delivery power signal is operated at a voltage of 5V, 9V, 15V, 19V, 24V, 40V or 48V.

In an embodiment, the connection interface is included in a first electronic device, and an additional connection interface is included in a second electronic device. The connection interface is coupled with a position-limiting coupling structure of the additional connection interface. Consequently, the connection interface and the additional connection interface are permitted to be coupled with each other in the unidirectional mating manner only.

In an embodiment, the position-limiting coupling structure includes a raised coupling structure or a recessed coupling structure.

In an embodiment, the position-limiting coupling structure includes a positioning recess or a positioning post.

In an embodiment, the connection interface is included in a modular peripheral device, and the modular peripheral device includes a host and at least one expansion unit. The host and the at least one expansion unit are connected with each other through the connection interface in a modular connecting manner.

In accordance with another aspect of the present invention, a connection interface for an electronic system is provided. The electronic system includes a first electronic device and a second electronic device. The connection interface is compatible with a hardware specification of a Type C universal serial bus. The connection interface includes a first connection interface hardware structure and a second connection interface hardware structure. The first connection interface hardware structure is included in the first electronic device and compatible with the hardware specification of the Type C universal serial bus. The first connection interface hardware structure has 24 metal docking structures. The second connection interface hardware structure is included in the second electronic device and compatible with the hardware specification of the Type C universal serial bus. The second connection interface hardware structure has 24 metal docking structures. The first connection interface hardware structure and the second connection interface hardware structure are permitted to be coupled with each other in a unidirectional mating manner only. The 24 metal docking structures of the first connection interface hardware structure and the 24 metal docking structures of the second connection interface hardware structure support simultaneous transmission of two USB2.0 data signals.

In an embodiment, one of the first connection interface hardware structure and the second connection interface hardware structure is a plug hardware structure compatible with the Type C universal serial bus, and the other of the first connection interface hardware structure and the second connection interface hardware structure is a receptacle hardware structure.

Preferably, in the 24 metal docking structures of each of the first connection interface hardware structure and the second connection interface hardware structure, four metal docking structures supports transmission of a first USB2.0 data signal, four metal docking structures supports transmission of a second USB2.0 data signal, and the four metal docking structures supporting transmission of the first USB2.0 data signal and other five metal docking structures collaboratively support transmission of a single USB3.0 data signal.

Preferably, in the 24 metal docking structures of each of the first connection interface hardware structure and the second connection interface hardware structure, at least two metal docking structures support transmission of I²C data signals, or at least four metal docking structures support transmission of GPIO data signals, or at least two metal docking structures support transmission of a fixed 3.3V power signal, or at least four metal docking structures support transmission of a fixed 19V power signal or a Power Delivery power signal, or at least four metal docking structures support transmission of a ground signal.

In an embodiment, the Power Delivery power signal is operated at a voltage of 5V, 9V, 15V, 19V, 24V, 40V or 48V.

In an embodiment, each of the first connection interface hardware structure and the second connection interface hardware structure includes a position-limiting coupling structure. The position-limiting coupling structure of the first connection interface hardware structure and the position-limiting coupling structure of the second connection interface hardware structure are coupled with each other. Consequently, the first connection interface hardware structure and the second connection interface hardware structure are permitted to be coupled with each other in the unidirectional mating manner only.

In an embodiment, the position-limiting coupling structure includes a raised coupling structure or a recessed coupling structure.

In an embodiment, the position-limiting coupling structure includes a positioning recess or a positioning post.

In an embodiment, the first electronic device is a host, the second electronic device is an expansion unit, and the electronic system is a modular peripheral device. The host and the expansion unit are connected with each other through the connection interface in a modular connecting manner.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the standard connection signal configuration for the hardware specifications of the commonly used USB-C plug connection interface;

FIG. 2 schematically illustrates the connection signal configuration for the hardware specifications of a USB-C plug connection interface TC according to an embodiment of the present invention;

FIG. 3 schematically illustrates the application of a connection interface in a modular peripheral device according to an embodiment of the present invention, in which the connection interface is compatible with the hardware specifications of Type C universal serial bus (USB-C);

FIG. 4A is a schematic perspective view illustrating a process of assembling two connection interfaces of the modular peripheral device shown in FIG. 3 through position-limiting coupling structures;

FIG. 4B is a schematic bottom view illustrating the expansion unit of the modular peripheral device shown in FIG. 3; and

FIG. 5 schematically illustrates the application of a connection interface in a modular peripheral device according to another embodiment of the present invention, in which the connection interface is compatible with the hardware specifications of Type C universal serial bus (USB-C).

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. Furthermore, in order to clearly show the technical features of the present invention, unnecessary elements that can be completed by conventional techniques are not shown in the drawings of the embodiments.

In order to overcome the drawbacks of the conventional technologies, the present invention provides a connection interface with enhanced use flexibility to provide simplified connection between different devices. In accordance with the technology of the present invention, the hardware structure of the existing Type-C universal serial bus (USB-C) connection interface is adopted. The metal docking structures in the hardware structure are redefined to support signal transmission between various electronic devices. This approach can fully use the existing cable hardware specifications to significantly reduce the development cost of connection interface. In addition, this approach meets the modular assembly requirement needed for signal transmission between different peripheral devices while increasing the application flexibility.

Hereinafter, the standard connection signal configuration of the commonly used USB-C plug connection interface will be illustrated. This serves as a foundation for subsequent explanations of the implementation examples and application scenarios involving modifications to the signal configuration of the connection interface of the present invention.

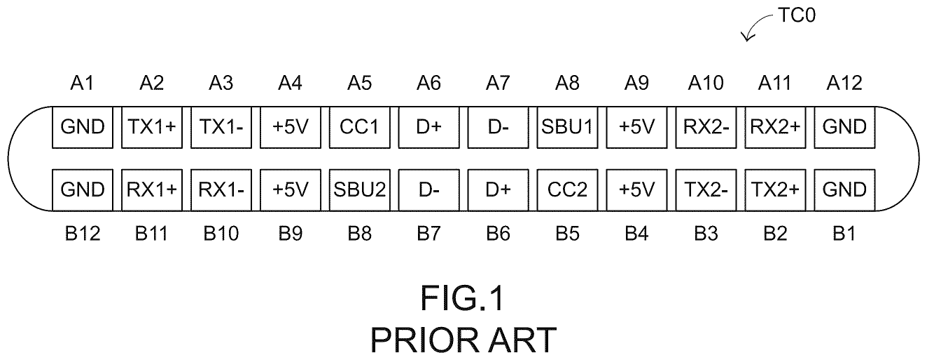

FIG. 1 schematically illustrates the standard connection signal configuration for the hardware specifications of the commonly used USB-C plug connection interface TC0. In conjunction, associated descriptions of the connection signals will be listed in the following table.

| Metal | | |
|---|---|---|
| docking | | |
| structure | Connection | |
| (No.) | signal | Description |
| A1 | GND | Ground signal |
| A2 | TX1+ | USB3.0 transmit signal of the first set |
| A3 | TX1− | USB3.0 transmit signal of the first set |
| A4 | +5 V | 5 V power supply |
| A5 | CC1 | PD communication signal of the first set |
| A6 | D+ | USB2.0/USB3.0 data signal of the first set |
| A7 | D− | USB2.0/USB3.0 data signal of the first set |
| A8 | SBU1 | Auxiliary signal of the first set |
| A9 | +5 V | 5 V power supply |
| A10 | RX2− | USB3.0 receive signal of the second set |
| A11 | RX2+ | USB3.0 receive signal of the second set |
| A12 | GND | Ground signal |
| B1 | GND | Ground signal |
| B2 | TX2+ | USB3.0 transmit signal of the second set |
| B3 | TX2− | USB3.0 transmit signal of the second set |
| B4 | +5 V | 5 V power supply |
| B5 | CC2 | PD communication signal of the second set |
| B6 | D+ | USB2.0/USB3.0 data signal of the second set |
| B7 | D− | USB2.0/USB3.0 data signal of the second set |
| B8 | SBU2 | Auxiliary signal of the second set |
| B9 | +5 V | 5 V power supply |
| B10 | RX1− | USB3.0 receive signal of the first set |
| B11 | RX1+ | USB3.0 receive signal of the first set |
| B12 | GND | Ground signal |

Please refer to FIG. 1 again. According to the hardware specifications, the conventional USB-C plug connection interface TC0 includes 24 metal docking structures A1~A12 and B1~B12. These 24 metal docking structures are symmetrically distributed within the connection interface in two sets, wherein each set contains 12 metal docking structures.

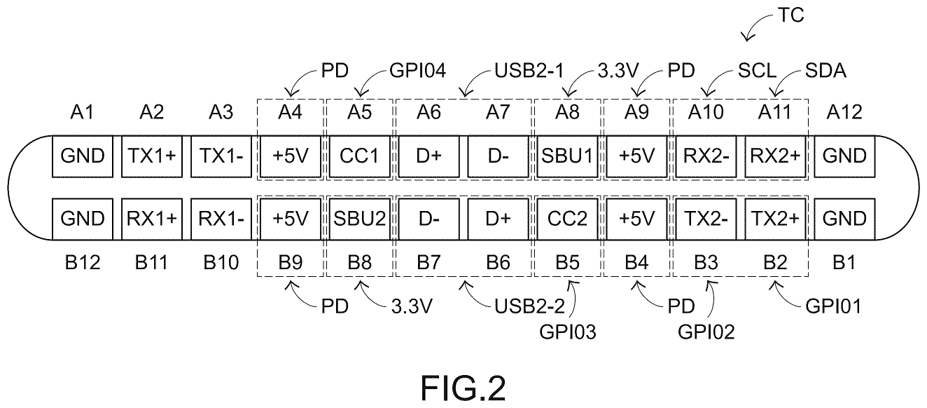

In accordance with a feature of the present invention, the connection interface TC of the present invention (see FIG. 2) is designed for achieving the unidirectional mating function rather than the bidirectional mating function. In other words, some metal docking structures in the connection interface TC0 of FIG. 1 originally reserved for bidirectional signal transmission according to the standard USB-C specifications are no longer required for that purpose. As a result, these unused metal docking structures can be repurposed and redefined to support additional functionalities, e.g., the transmission of an additional USB2.0 data signal, the Inter-Integrated Circuit (I²C) communication, the 3.3V power supply, the 19V power supply, multiple Power Delivery (PD) channels, and General-Purpose Input/Output (GPIO) interfaces. Due to the special structural design, the connection interface of the present invention can simultaneously support one USB3.0 interface, two USB2.0 interfaces, I²C communication, 3.3V power supply, 19V power supply, multiple PD channels, and GPIO signal transmission.

FIG. 2 schematically illustrates the connection signal configuration for the hardware specifications of a USB-C plug connection interface TC according to an embodiment of the present invention. In conjunction, associated descriptions of the connection signals will be listed in the following table. For clarity and ease of reference, the redefined metal docking structures are underlined in the table.

| Metal docking structure (No.) | Connection signal | Description |
|---|---|---|
| A1 | GND | Ground signal |
| A2 | TX1+ | Transmission signal of the single USB3.0 set |
| A3 | TX1− | Transmission signal of the single USB3.0 set |
| A4 | PD | 19 V power supply or Power Delivery (PD) signal |
| A5 | GPIO4 | GPIO signal of the fourth set |
| A6 | D+ | USB2.0/USB3.0 data signal of the first set |
| A7 | D− | USB2.0/USB3.0 data signal of the first set |
| A8 | +3.3 V | 3.3 V power supply |
| A9 | PD | 19 V power supply or Power Delivery (PD) signal |
| A10 | SCL | I²C serial clock signal |
| A11 | SDA | I²C serial data signal |
| A12 | GND | Ground signal |
| B1 | GND | Ground signal |
| B2 | GPIO1 | GPIO signal of the first set |
| B3 | GPIO2 | GPIO signal of the second set |
| B4 | PD | 19 V power supply or Power Delivery (PD) signal |
| B5 | GPIO3 | GPIO signal of the third set |
| B6 | D+ | USB2.0 data signal of the second set |
| B7 | D− | USB2.0 data signal of the second set |
| B8 | +3.3 V | 3.3 V power supply |
| B9 | PD | 19 V power supply or Power Delivery (PD) signal |
| B10 | RX1− | Receive signal of the single USB3.0 set |
| B11 | RX1+ | Receive signal of the single USB3.0 set |
| B12 | GND | Ground signal |

Similarly, some metal docking structures in the conventional USB-C receptacle connection interface can be repurposed and redefined to support additional functionalities. That is, the connection signal configuration for the hardware specifications of USB-C receptacle connection interface is identical or similar to that of FIG. 2, and not redundantly described herein.

In the metal docking structures A1~A12 and B1~B12 listed in the above table and shown in FIG. 2, a first set of four metal docking structures (A1, A4, A6, A7) support the signal transmission compatible with the USB2.0 specification (i.e., support the transmission of a USB2.0 data signal). Furthermore, the metal docking structures (A6, A7) are collaboratively formed as a data signal line USB2-1 compatible with the USB2.0 specification.

In the metal docking structures A1~A12 and B1~B12, a second set of four metal docking structures (B6, B7, B9, B12) also support the signal transmission compatible with the USB2.0 specification (i.e., support the transmission of another USB2.0 data signal). Furthermore, the metal docking structures (B6, B7) are collaboratively formed as another data signal line USB2-2 compatible with the USB2.0 specification.

As mentioned above, in the connection interface TC of the present invention, the first set of four metal docking structures (A1, A4, A6, A7) support the signal transmission compatible with the USB2.0 specification, and the second set of four metal docking structures (B6, B7, B9, B12) support the signal transmission compatible with the USB2.0 specification. When necessary, the connection interface is capable of simultaneously supporting two independent USB2.0 signal transmissions.

Furthermore, the four metal docking structures (A1, A4, A6, A7) and additional five metal docking structures (A2, A3, B10, B11, B1) are combined as a single set of nine metal docking structures, which support the signal transmission compatible with the USB3.0 specification (i.e., support the transmission of a USB3.0 data signal).

In the metal docking structures A1~A12 and B1~B12, two metal docking structures (A10, A11) support the signal transmission compatible with the I²C specification, and four metal docking structures (B2, B3, B5, A5) support the signal transmission compatible with the GPIO specification.

In the metal docking structures A1~A12 and B1~B12, at least two metal docking structures (A8, B8) support the power signal transmission of a fixed 3.3V power supply, and four metal docking structures (A4, A9, B4, B9) support the power signal transmission of a fixed 19V power supply or the power signal transmission compatible with the Power Delivery (PD) specification.

Furthermore, according to the practical requirements, the four metal docking structures (A4, A9, B9, B4) support power signal transmission under the Power Delivery (PD) specification to provide a wider range of voltage operation options. For example, these metal docking structures can provide at least one of the following voltages: 5V, 9V, 15V, 19V, 24V, 40V or 48V.

In the metal docking structures A1~A12 and B1~B12, four metal docking structures (A1, A12, B1, B12) can provide a grounding function.

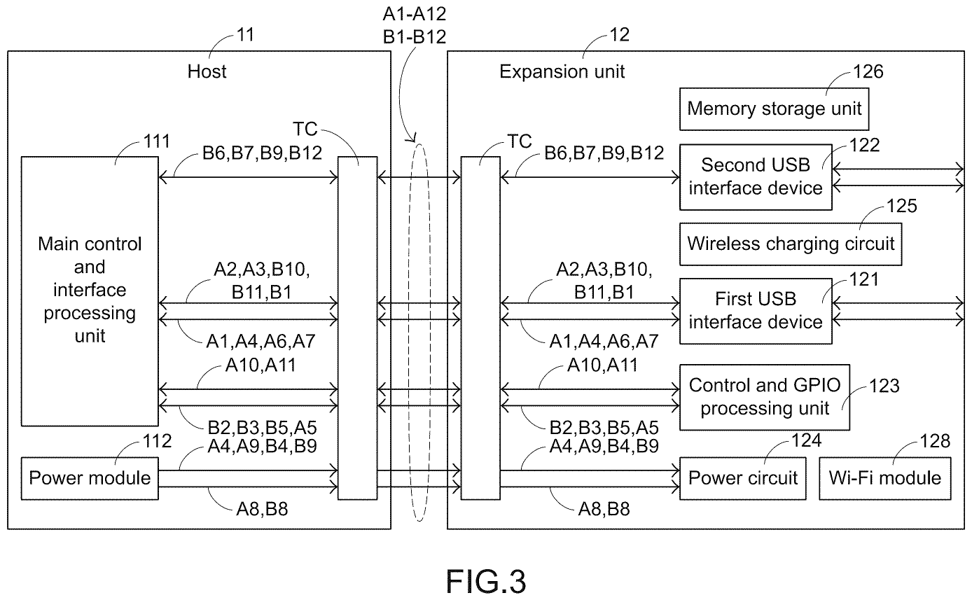

The present invention provides a connection interface TC for connecting different devices in a flexible and simplified manner. An application example of the connection interface TC will be illustrated with reference to FIG. 3. FIG. 3 schematically illustrates the application of a connection interface in a modular peripheral device according to an embodiment of the present invention, in which the connection interface is compatible with the hardware specifications of Type C universal serial bus (USB-C).

In FIG. 3, a modular peripheral device is shown. The modular peripheral device includes a host 11 and an expansion unit 12. Each of the host 11 and the expansion unit 12 is equipped with a connection interface TC. In addition, the host 11 and the expansion unit 12 are connected with each other through the corresponding connection interfaces TC in a modular connecting manner. The signal transmission between the host 11 and the expansion unit 12 is implemented according to the USB2.0/USB3.0 specifications. Furthermore, communication some functions of the expansion unit 12 are implemented by using the signal transmission according to the I²C specification, which adopts a master/slave architecture.

The host 11 at least includes a main control and interface processing unit 111 and a power module 112. The expansion unit 12 at least includes a first USB interface device 121, a second USB interface device 122, a control and GPIO processing unit 123, a power circuit 124, a wireless charging circuit 125, a memory storage unit 126 and a Wi-Fi module 128.

Each of the host 11 and the expansion unit 12 is equipped with a connection interface TC. For example, one connection interface TC is a USB-C plug, and the other connection interface TC is a USB-C receptacle. Alternatively, the two connection interfaces TC are both USB-C receptacles, and these two connection interfaces TC are connected with each other through a transmission cable with USB-C receptacles at two terminals. That is, the type of the connection interface TC is not restricted. Of course, each connection interface TC includes 24 metal docking structures A1~A12 and B1~B12.

The first USB interface device 121 is electrically connected with the first set of four metal docking structures (A1, A4, A6, A7), which support the signal transmission compatible with the USB2.0 specification. Furthermore, the four metal docking structures (A1, A4, A6, A7) and additional five metal docking structures (A2, A3, B10, B11, B1) are combined as a single set of nine metal docking structures, which support the signal transmission compatible with the USB3.0 specification.

Furthermore, the first USB interface device 121 includes a shared USB2.0/USB3.0 port (not shown). Alternatively, the first USB interface device 121 includes both a USB2.0 port (not shown) and a USB3.0 port (not shown). Consequently, the first USB interface device 121 can be connected with one of the electronic peripheral devices (not shown) that support USB2.0 and/or USB3.0 specifications.

In an embodiment, the second USB interface device 122 is electrically connected with the second set of four metal docking structures (B6, B7, B9, B12), which support the signal transmission compatible with the USB2.0 specification. Consequently, the second USB interface device 122 can be connected with one of the electronic peripheral devices (not shown) that support the USB2.0 specification.

Furthermore, the second USB interface device 122 includes a USB2.0 port (not shown).

Generally, the expansion unit 12 provides some peripheral application functions. For example, the wireless charging circuit 125 provides a wireless charging function, or the memory storage unit 126 provides a data storage function. Furthermore, in order to facilitate the connection between the host 11 and the expansion unit 12 in a modular assembling manner, the host 11 can be connected with other peripheral electronic devices (not shown) in an expansible connection manner through the first USB interface device 121 or the second USB interface device 122. In an embodiment, the user can perform overall or partial signal control through the Wi-Fi module 128 of the expansion unit 12.

The power circuit 124 included in the expansion unit 12 is electrically connected with the two metal docking structures (A8, B8) that support the power signal transmission of a fixed 3.3V power supply, and/or the power circuit 124 is electrically connected with the four metal docking structures (A4, A9, B4, B9) support the power signal transmission of a fixed 19V power supply or the power signal transmission compatible with the Power Delivery (PD) specification.

Furthermore, according to the practical applications of the expansion unit 12 or the electronic peripheral devices (not shown), the four metal docking structures (A4, A9, B9, B4) support power signal transmission under the Power Delivery (PD) specification to provide a wider range of voltage operation options. For example, these metal docking structures can provide at least one of the following voltages: 5V, 9V, 15V, 19V, 24V, 40V or 48V.

In an embodiment, the two metal docking structures (A10, A11) supporting the signal transmission compatible with the I²C specification and the four metal docking structures (B2, B3, B5, A5) supporting the signal transmission compatible with the GPIO specification are connected between the main control and interface processing unit 111 of the host 11 and the control and GPIO processing unit 123 of the expansion unit 12. The four metal docking structures (B2, B3, B5, A5) are provided to support the signal transmission compatible with the GPIO specification. When this newly designed TC connection interface is applied to the modular peripheral device, these GPIO signals can be used as a basis for determining whether any expansion unit to be assembled into the modular peripheral device belongs to the same product series.

In an embodiment, the host 11 can control the operations of the expansion unit 12. Alternatively, the host 11 is in communication with a computer (not shown), and the computer is allowed to perform overall or partial signal control.

As mentioned above, the TC connection interface of the present invention does not support the bidirectional mating function. Consequently, the connection interface TC needs to be equipped with a foolproof mechanism. In order to further explain the modular assembly process between the main unit 11 and the expansion unit 12 as shown in FIG. 3, the design of the foolproof mechanism will be illustrated as follows.

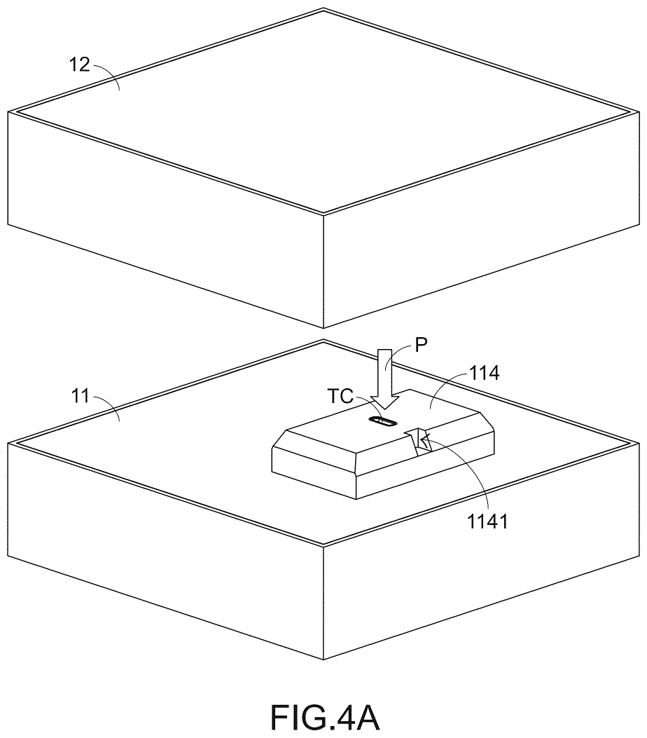

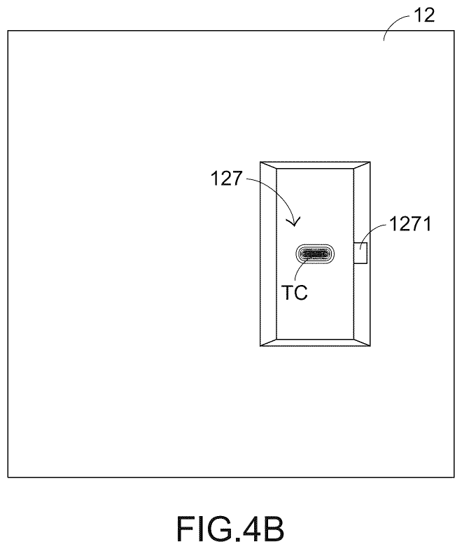

FIG. 4A is a schematic perspective view illustrating a process of assembling two connection interfaces of the modular peripheral device shown in FIG. 3 through position-limiting coupling structures. FIG. 4B is a schematic bottom view illustrating the expansion unit of the modular peripheral device shown in FIG. 3.

As shown in FIG. 4A and FIG. 4B, the host 11 and the expansion unit 12 are assembled in a modular manner using a vertical stacking approach. For example, the expansion unit 12 is mounted onto the top side of the host 11 through a downward assembling action P.

A position-limiting coupling structure (e.g., a raised coupling structure 114) is arranged beside the connection interface TC of the host 11. Another position-limiting coupling structure (e.g., a recessed coupling structure 127) is arranged beside the connection interface TC of the expansion unit 12. The raised coupling structure 114 and the recessed coupling structure 127 are coupled with each other. Due to this structural design, only the unidirectional mating function of the two connection interfaces TC is achievable, and the bidirectional mating function is not permitted. In other words, the foolproof mechanism is effective to achieve the unidirectional mating function.

For increasing the stability of connecting TC connection interface of the host 11 and the TC connection interface of the expansion unit 12, the raised coupling structure 114 is further equipped with a positioning recess 1141, and the recessed coupling structure 127 is further equipped with a positioning post 1271. Due to the engagement between the positioning recess 1141 and the positioning post 1271, the stability of the connection between the host 11 and the expansion unit 12 can be effectively enhanced.

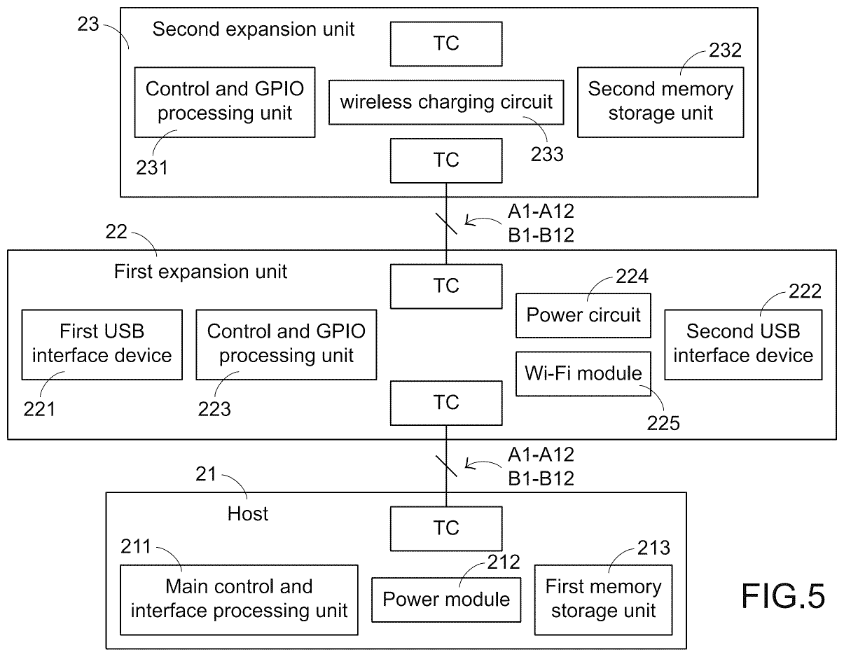

FIG. 5 schematically illustrates the application of a connection interface in a modular peripheral device according to another embodiment of the present invention, in which the connection interface is compatible with the hardware specifications of Type C universal serial bus (USB-C).

The operating principles of the modular peripheral device shown in FIG. 5 are similar to those of the modular peripheral device shown in FIG. 3. In comparison with FIG. 3, the modular peripheral device shown in FIG. 5 includes more expansion units and the locations of some components are distinguished. Since various peripheral devices can be assembled in a modular manner through the connection interfaces of the present invention, the use flexibility and convenience will be enhanced.

In FIG. 5, a modular peripheral device is shown. The modular peripheral device includes a host 21, a first expansion unit 22 and a second expansion unit 23. Each of the host 21, a first expansion unit 22 and a second expansion unit 23 is equipped with a connection interface TC. In addition, the host 21, the first expansion unit 22 and the second expansion unit 23 are connected with each other through the corresponding connection interfaces TC in a modular connecting manner. The signal transmission between the host 21, the first expansion unit 22 and the second expansion unit 23 is implemented according to the USB2.0/USB3.0 specifications. Furthermore, communication some functions of the first expansion unit 22 and the second expansion unit 23 are implemented by using the signal transmission according to the I²C specification, which adopts a master/slave architecture.

The host 21 at least includes a main control and interface processing unit 211, a power module 212 and a first memory storage unit 213. The first expansion unit 22 at least includes a first USB interface device 221, a second USB interface device 222, a control and GPIO processing unit 223, a power circuit 224 and a Wi-Fi module 225. The second expansion unit 23 at least includes a control and GPIO processing unit 231, a second memory storage unit 232 and a wireless charging circuit 233. Of course, the connection interface TC in each of the host 21, the first expansion unit 22 and the second expansion unit 23 includes 24 metal docking structures A1~A12 and B1~B12.

From the above descriptions, the present invention provides a connection interface. In accordance with the technology of the present invention, the hardware structure of the existing Type-C universal serial bus (USB-C) connection interface is adopted. The metal docking structures in the hardware structure are redefined to support signal transmission between various electronic devices. This approach can fully use the existing cable hardware specifications to significantly reduce the development cost of connection interface. In addition, this approach meets the modular assembly requirement needed for signal transmission between different peripheral devices while increasing the application flexibility. In other words, the connection interface of the present invention are industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A connection interface compatible with a hardware specification of a Type C universal serial bus, the connection interface comprising:
a connection interface hardware structure compatible with the hardware specification of the Type C universal serial bus, wherein the connection interface is one of a plug connection interface and a receptacle connection interface compatible with the Type C universal serial bus; and
24 metal docking structures symmetrically distributed within the connection interface in two sets, wherein each set contains 12 metal docking structures,
wherein the 24 metal docking structures support simultaneous transmission of two USB2.0 data signals.

2. The connection interface according to claim 1, wherein in the 24 metal docking structures, four metal docking structures supporting transmission of one of the two USB2.0 data signals and other five metal docking structures collaboratively support transmission of a single USB3.0 data signal.

3. The connection interface according to claim 1, wherein in the 24 metal docking structures, at least two metal docking structures support transmission of I²C data signals, or at least four metal docking structures support transmission of GPIO data signals, or at least two metal docking structures support transmission of a fixed 3.3V power signal, or at least four metal docking structures support transmission of a fixed 19V power signal or a Power Delivery power signal, or at least four metal docking structures support transmission of a ground signal.

4. The connection interface according to claim 1, wherein the Power Delivery power signal is operated at a voltage of 5V, 9V, 15V, 19V, 24V, 40V or 48V.

5. The connection interface according to claim 1, wherein the connection interface is included in a first electronic device, and an additional connection interface is included in a second electronic device, wherein the connection interface is coupled with a position-limiting coupling structure of the additional connection interface, so that the connection interface and the additional connection interface are permitted to be coupled with each other in a unidirectional mating manner only.

6. The connection interface according to claim 5, wherein the position-limiting coupling structure includes a raised coupling structure or a recessed coupling structure.

7. The connection interface according to claim 5, wherein the position-limiting coupling structure includes a positioning recess or a positioning post.

8. The connection interface according to claim 1, wherein the connection interface is included in a modular peripheral device, and the modular peripheral device includes a host and at least one expansion unit, wherein the host and the at least one expansion unit are connected with each other through the connection interface in a modular connecting manner.

9. The connection interface according to claim 8, wherein the modular peripheral device at least comprises a Wi-Fi module, at least one memory storage unit, a wireless charging circuit, a first USB interface device, a second USB interface device and a power circuit.

10. The connection interface according to claim 9, wherein the first USB interface device is electrically connected with four metal docking structures of the 24 metal docking structures to support transmission of a first one of the two USB2.0 data signals, or the first USB interface device is electrically connected with the four metal docking structures of the 24 metal docking structures to support transmission of the first one of the USB2.0 data signals and other five metal docking structures to support transmission of a single USB3.0 data signal.

11. The connection interface according to claim 10, wherein the first USB interface device comprises a shared USB2.0/USB3.0 port, or the first USB interface device comprises a USB2.0 port and a USB3.0 port.

12. The connection interface according to claim 9, wherein the second USB interface device is electrically connected with four metal docking structures of the 24 metal docking structures to support transmission of a second one of the two USB2.0 data signals.

13. The connection interface according to claim 12, wherein the second USB interface device comprises a USB2.0 port.

14. The connection interface according to claim 9, wherein the power circuit is electrically connected with two metal docking structures of the 24 metal docking structures to support transmission of a fixed 3.3V power signal, or the power circuit is electrically connected with four metal docking structures of the 24 metal docking structures to support transmission of a fixed 19V power signal or a Power Delivery power signal.

15. A connection interface compatible with a hardware specification of a Type C universal serial bus, the connection interface comprising:
a connection interface hardware structure compatible with the hardware specification of the Type C universal serial bus, wherein the connection interface is one of a plug connection interface and a receptacle connection interface compatible with the Type C universal serial bus; and
24 metal docking structures distributed within the connection interface, wherein the 24 metal docking structures are permitted to be connected in a unidirectional mating manner only,
wherein in the 24 metal docking structures, four metal docking structures supports transmission of a first USB2.0 data signal, four metal docking structures supports transmission of a second USB2.0 data signal, and the four metal docking structures supporting transmission of the first USB2.0 data signal and other five metal docking structures collaboratively support transmission of a single USB3.0 data signal.

16. The connection interface according to claim 15, wherein in the 24 metal docking structures, at least two metal docking structures support transmission of I²C data signals, or at least four metal docking structures support transmission of GPIO data signals, or at least two metal docking structures support transmission of a fixed 3.3V power signal, or at least four metal docking structures support transmission of a fixed 19V power signal or a Power Delivery power signal, or at least four metal docking structures support transmission of a ground signal.

17. The connection interface according to claim 16, wherein the Power Delivery power signal is operated at a voltage of 5V, 9V, 15V, 19V, 24V, 40V or 48V.

18. The connection interface according to claim 15, wherein the connection interface is included in a first electronic device, and an additional connection interface is included in a second electronic device, wherein the connection interface is coupled with a position-limiting coupling structure of the additional connection interface, so that the connection interface and the additional connection interface are permitted to be coupled with each other in the unidirectional mating manner only.

19. The connection interface according to claim 18, wherein the position-limiting coupling structure includes a raised coupling structure or a recessed coupling structure.

20. The connection interface according to claim 18, wherein the position-limiting coupling structure includes a positioning recess or a positioning post.

21. The connection interface according to claim 15, wherein the connection interface is included in a modular peripheral device, and the modular peripheral device includes a host and at least one expansion unit, wherein the host and the at least one expansion unit are connected with each other through the connection interface in a modular connecting manner.

22. A connection interface for an electronic system, the electronic system comprising a first electronic device and a second electronic device, the connection interface being compatible with a hardware specification of a Type C universal serial bus, the connection interface comprising:
a first connection interface hardware structure included in the first electronic device, and compatible with the hardware specification of the Type C universal serial bus, wherein the first connection interface hardware structure has 24 metal docking structures; and
a second connection interface hardware structure included in the second electronic device, and compatible with the hardware specification of the Type C universal serial bus, wherein the second connection interface hardware structure has 24 metal docking structures, and the first connection interface hardware structure and the second connection interface hardware structure are permitted to be coupled with each other in a unidirectional mating manner only,
wherein the 24 metal docking structures of the first connection interface hardware structure and the 24 metal docking structures of the second connection interface hardware structure support simultaneous transmission of two USB2.0 data signals.

23. The connection interface according to claim 22, wherein one of the first connection interface hardware structure and the second connection interface hardware structure is a plug hardware structure compatible with the Type C universal serial bus, and the other of the first connection interface hardware structure and the second connection interface hardware structure is a receptacle hardware structure.

24. The connection interface according to claim 22, wherein in the 24 metal docking structures of each of the first connection interface hardware structure and the second connection interface hardware structure, four metal docking structures supports transmission of a first USB2.0 data signal, four metal docking structures supports transmission of a second USB2.0 data signal, and the four metal docking structures supporting transmission of the first USB2.0 data signal and other five metal docking structures collaboratively support transmission of a single USB3.0 data signal.

25. The connection interface according to claim 22, wherein in the 24 metal docking structures of each of the first connection interface hardware structure and the second connection interface hardware structure, at least two metal docking structures support transmission of I²C data signals, or at least four metal docking structures support transmission of GPIO data signals, or at least two metal docking structures support transmission of a fixed 3.3V power signal, or at least four metal docking structures support transmission of a fixed 19V power signal or a Power Delivery power signal, or at least four metal docking structures support transmission of a ground signal.

26. The connection interface according to claim 25, wherein the Power Delivery power signal is operated at a voltage of 5V, 9V, 15V, 19V, 24V, 40V or 48V.

27. The connection interface according to claim 22, wherein each of the first connection interface hardware structure and the second connection interface hardware structure comprises a position-limiting coupling structure, wherein the position-limiting coupling structure of the first connection interface hardware structure and the position-limiting coupling structure of the second connection interface hardware structure are coupled with each other, so that the first connection interface hardware structure and the second connection interface hardware structure are permitted to be coupled with each other in the unidirectional mating manner only.

28. The connection interface according to claim 27, wherein the position-limiting coupling structure includes a raised coupling structure or a recessed coupling structure.

29. The connection interface according to claim 27, wherein the position-limiting coupling structure includes a positioning recess or a positioning post.

30. The connection interface according to claim 22, wherein the first electronic device is a host, the second electronic device is an expansion unit, and the electronic system is a modular peripheral device, wherein the host and the expansion unit are connected with each other through the connection interface in a modular connecting manner.
